(19) United States
(12) Patent Application Publication
(10) Pub. No.: US 2018/0211647 A1
(43) Pub. Date: Jul. 26, 2018

(54) ACTIVE NOISE REDUCTION DEVICE, VEHICLE, AND ABNORMALITY DETERMINATION METHOD

(71) Applicant: Panasonic Intellectual Property Management Co., Ltd., Osaka (JP)

(72) Inventor: MITSUHIRO TANI, Osaka (JP)

(21) Appl. No.: 15/865,461

(22) Filed: Jan. 9, 2018

(30) Foreign Application Priority Data
Jan. 25, 2017 (JP) 2017-011487

(51) Int. Cl. G10K 11/178; H04R 3/02

(52) U.S. Cl. CPC G10K 11/17821; H04R 3/02; G10K 2210/1282; G10K 11/17854; G10K 11/17881

(57) ABSTRACT

An active noise reduction device reduces noise in a space within a vehicle body. The active noise reduction device includes a first input unit, a signal processor, and an abnormality determiner. The first input unit acquires, from a first vibration detector fitted to the vehicle body, a first signal that indicates a magnitude of vibration in a specific part of the vehicle body. The signal processor generates a cancellation signal that is used to output a cancellation sound for reducing the noise, by using the first signal as a reference signal having a correlation with the noise. The abnormality determiner determines whether or not an abnormality is present in the specific part by using the first signal.

### BACKGROUND

### 1. Technical Field

The present disclosure relates to an active noise reduction device that actively reduces noise by causing a cancellation sound to interfere with the noise. The present disclosure also relates to a vehicle incorporating the same, and an abnormality determination method.

### 2. Description of the Related Art

An active noise reduction device that has a cancellation sound source and actively reduces noise is conventionally known. This type of device outputs a cancellation sound for cancelling noise, for example, by using a reference signal having a correlation with noise, and an error signal based on a residual sound generated by an interference between the noise within a predetermined space and the cancellation sound (see, for example, International Publication No. 2014/006846). The active noise reduction device uses an adaptive filter to generate a cancellation signal so that the sum of squares of the error signal becomes the minimum.

### SUMMARY

The present disclosure provides an active noise reduction device and so on that can determine whether or not an abnormality is present in a vehicle without increasing the number of sensors.

An active noise reduction device according to an aspect of the present disclosure reduces noise in a space within a vehicle body. The active noise reduction device includes a first input unit, a signal processor, and an abnormality determiner. The first input unit acquires, from a first vibration detector fitted to the vehicle body, a first signal that indicates a vibration in a specific part of the vehicle body. The signal processor generates a cancellation signal that is used to output a cancellation sound for reducing the noise, by using the first signal as a reference signal having a correlation with the noise. The abnormality determiner determines whether or not an abnormality is present in the specific part by using the first signal.

A vehicle according to an aspect of the present disclosure includes a vehicle body, an active noise reduction device, and a first vibration detector. The vehicle body is provided with a space therein. The first vibration detector is fitted to the vehicle body, and outputs a first signal indicating a vibration in a specific part of the vehicle body. The active noise reduction device is configured as in the foregoing.

An abnormality determination method according to an aspect of the present disclosure is performed by an active noise reduction device that reduces noise in a space within a vehicle body. According to the method, a first signal that indicates a magnitude of vibration is first acquired from a first vibration detector fitted to a specific part of the vehicle body. Then, a cancellation signal that is used to output a cancellation sound for reducing the noise is generated by using the first signal as a reference signal having a correlation with the noise. Also, whether or not an abnormality is present in the specific part is determined by using the same first signal.

The active noise reduction device according to the present disclosure can determine whether or not an abnormality is present in a vehicle without increasing the number of sensors.

### BRIEF DESCRIPTION OF DRAWINGS

FIG. 1 is a schematic view illustrating a vehicle incorporating an active noise reduction device according to a first exemplary embodiment, viewed from top.

FIG. 2 is a schematic view illustrating the vehicle shown in FIG. 1, viewed from a side.

FIG. 3 is a block diagram illustrating a functional configuration of the active noise reduction device according to the first exemplary embodiment of the present disclosure.

FIG. 4 is a flowchart illustrating a noise reduction operation of the active noise reduction device shown in FIG. 3.

FIG. 5 is a flowchart illustrating an abnormality determination operation of the active noise reduction device shown in FIG. 3.

FIG. 6 is a schematic view illustrating a signal waveform of a first signal to be acquired by the active noise reduction device shown in FIG. 3.

FIG. 7 is a schematic view illustrating a vehicle incorporating an active noise reduction device according to a second exemplary embodiment, viewed from top.

FIG. 8 is a schematic view illustrating the vehicle shown in FIG. 7, viewed from a side.

FIG. 9 is a block diagram illustrating a functional configuration of the active noise reduction device according to the second exemplary embodiment of the present disclosure.

FIG. 10 is a flowchart illustrating an abnormality determination operation of the active noise reduction device shown in FIG. 9.

FIG. 11A is a schematic view illustrating a signal waveform of a first signal to be acquired by the active noise reduction device shown in FIG. 9.

FIG. 11B is a schematic view illustrating a signal waveform of a second signal to be acquired by the active noise reduction device shown in FIG. 9.

FIG. 12 is a view illustrating an example of an arrangement of vibration detectors and cancellation sound sources in the exemplary embodiments of the present disclosure.

### DETAILED DESCRIPTION OF PREFERRED EMBODIMENTS

Problems with conventional technology will be described briefly prior to describing exemplary embodiments of the present disclosure. In order to determine whether or not an abnormality is present in a vehicle, it is necessary to fit a sensor for detecting the abnormality to the vehicle. This requires the vehicle to have an additional location for fitting the sensor, which may adversely affect the design freedom of the vehicle. Moreover, because the man-hour for fitting the sensor becomes necessary, the total man-hour for assembling the vehicle increases.

Hereafter, exemplary embodiments of the present disclosure will be described in detail with reference to the drawings. All the exemplary embodiments described hereinbelow illustrate generic or specific examples. The numerical values, shapes, materials, structural elements, arrangements and connections of the structural elements, steps, order of the steps, etc. shown in the following exemplary embodiments are merely examples, and therefore do not limit the scope of the present disclosure. In addition, among the constituent elements in the following exemplary embodiments, those not recited in any one of the independent claims which indicate the broadest inventive concepts are described as optional elements.

The drawings are schematic and do not necessarily depict the elements exactly. In the drawings, substantially the same parts are designated by the same reference numerals, and the repetitive description thereof may be omitted or simplified.

### First Exemplary Embodiment

[Configuration of Vehicle incorporating Active Noise Reduction Device]

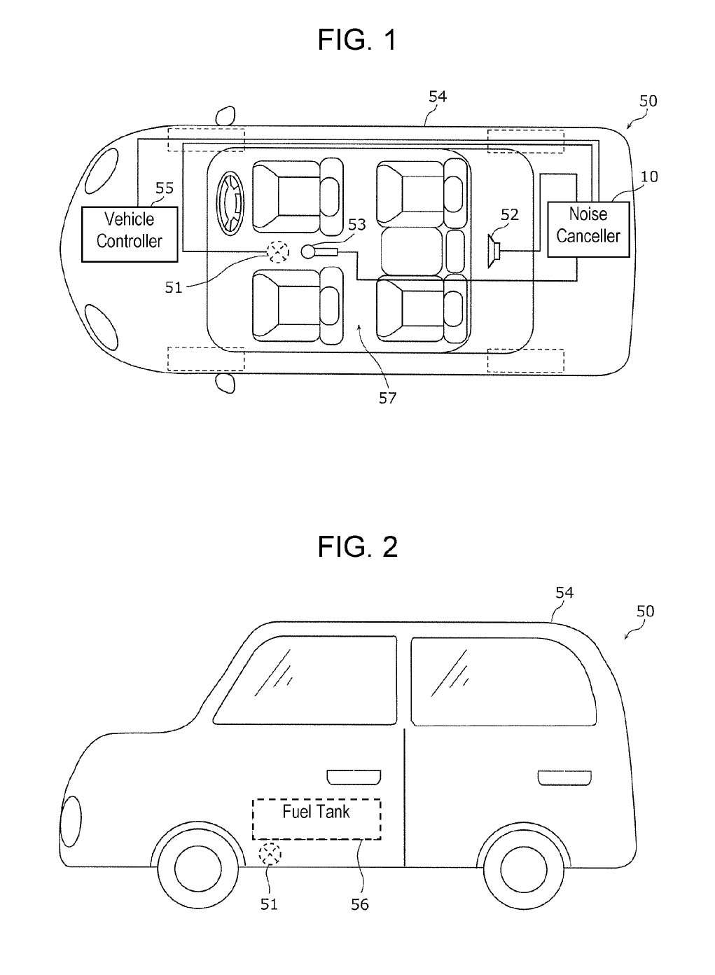

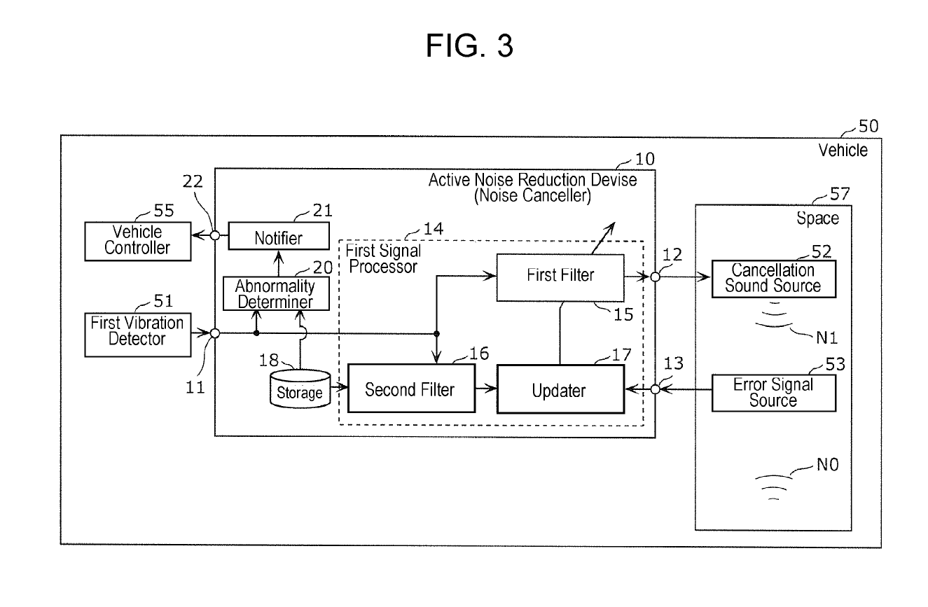

FIG. 1 is a schematic view illustrating vehicle 50 incorporating active noise reduction device (hereafter “noise canceller”) 10 according to a first exemplary embodiment, viewed from top. FIG. 2 is a schematic view illustrating vehicle 50, viewed from a side. FIG. 3 is a block diagram illustrating a functional configuration of noise canceller 10. The present exemplary embodiment describes noise canceller 10 to be incorporated in vehicle body 54.

Vehicle 50 is an example of mobile apparatus. Vehicle 50 includes noise canceller 10, first vibration detector (hereafter “sensor”) 51, cancellation sound source 52, error signal source 53, vehicle body 54, vehicle controller 55, and fuel tank 56. Specifically, vehicle 50 may be, but is not particularly limited to, an automobile.

Sensor 51 is fitted to a specific part of vehicle 50 (vehicle body 54) to detect a vibration in the specific part. The specific part may be, but is not particularly limited to, for example, fuel tank 56. It is enough that sensor 51 is fitted to a specific part that is the subject of vibration measurement.

Sensor 51 outputs, as a detection result of vibration, a first signal that indicates a vibration in fuel tank 56 (i.e., the specific part). The first signal has a correlation with noise NO (see FIG. 3) in space 57. As will be described later, noise canceller 10 uses the first signal as a reference signal for reducing noise. In addition, noise canceller 10 uses the first signal also as a signal for determining abnormality. In other words, the first signal is used for two operations, an abnormality determination operation and a noise reduction operation. This allows vehicle 50 to eliminate the need of an additional vibration detector (sensor) for the purpose of determining abnormality. Thus, noise canceller 10 is able to determine whether or not an abnormality is present in vehicle 50 without increasing the number of vibration detectors (sensors).

Sensor 51 is, for example, an acceleration sensor. As illustrated in FIG. 2, sensor 51 is fitted to, for example, fuel tank 56, which is provided under the floor of vehicle body 54. Note that sensor 51 may be another type of sensor that can detect a vibration directly or indirectly.

Cancellation sound source 52 outputs a cancellation sound to a predetermined space by using a cancellation signal. In the present exemplary embodiment, cancellation sound source 52 is a speaker. However, it is also possible that the cancellation sound may be output by vibrating a part of the structural elements of vehicle 50 (for example, a sunroof) with a driving mechanism, such as an actuator. Moreover, noise canceller 10 may employ a plurality of cancellation sound sources 52. The locations of cancellation sound sources 52 are not limited to particular locations.

Error signal source 53 detects a residual sound that is obtained by interference between a noise and a cancellation sound in space 57, and error signal source 53 outputs an error signal based on the residual sound. Error signal source 53 is a transducer, such as a microphone, and it is desirable that error signal source 53 be provided within space 57, such as in a headliner. It is also possible that vehicle 50 may have a plurality of error signal sources 53.

Vehicle body 54 is a structural element made up of components such as chassis and frames. Vehicle body 54 forms space 57 (vehicle compartment space) in which cancellation sound source 52 and error signal source 53 are to be disposed. That is, space 57 is provided within vehicle body 54.

Vehicle controller 55 controls (or drives) vehicle 50 based on, for example, operations performed by the driver of vehicle 50. Vehicle controller 55 is, for example, an electronic control unit (ECU). Specifically, vehicle controller 55 is composed of a computer processor, a microcomputer, and programs executed by them, or a dedicated circuit, for example. The hardware of vehicle controller 55 may be implemented by a combination of any two or more of a computer processor, a microcomputer, and a dedicated circuit.

Fuel tank 56 is a container that stores the fuel of vehicle 50. Fuel tank 56 is, for example, a gasoline tank. Fuel tank 56 may store light oil, natural gas, hydrogen, or the like. Thus, fuel tank 56 may store either liquid fuel or gas fuel. The fuel to be stored in fuel tank 56 is not limited to a particular fuel.

### [Configuration of Active Noise Reduction Device]

Next, the configuration of noise canceller 10 will be described with reference to FIG. 3.

Noise canceller 10 includes first input terminal 11, cancellation signal output terminal 12, error signal input terminal 13, first signal processor 14, memory storage 18, abnormality determiner 20, notifier 21, and notification signal output terminal 22. First signal processor 14 includes first filter 15, second filter 16, and updater 17. For example, first signal processor 14 is implemented by a computer processor, such as a digital signal processor (DSP), but it may also be implemented by a microcomputer and programs executed by the microcomputer, or dedicated circuits and combinations thereof.

### [Noise Reduction Operation]

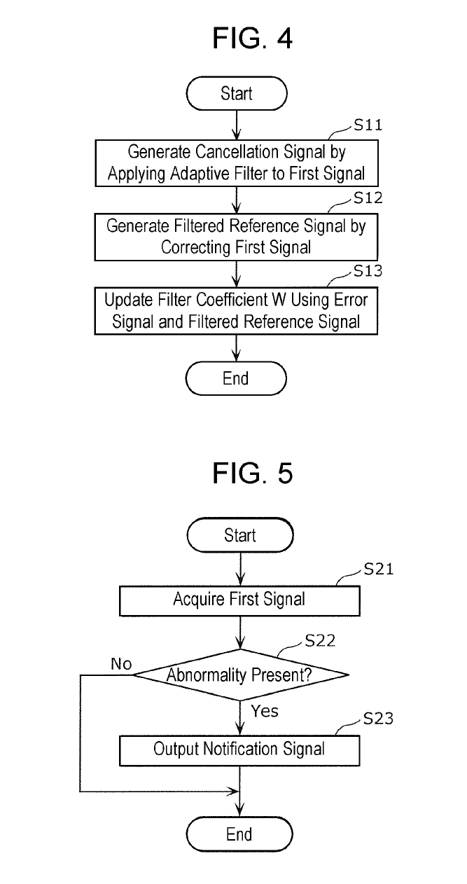

As described above, noise canceller 10 performs a noise reduction operation and an abnormality determination operation. First, the noise reduction operation of noise canceller 10 is described with reference to FIG. 4, in addition to FIG. 3. FIG. 4 is a flowchart illustrating the noise reduction operation of noise canceller 10.

At first, first signal processor 14 generates a cancellation signal by using the first signal that has been input to first input terminal 11 as a reference signal having a correlation with noise N0. The cancellation signal is used to output cancellation sound N1 for reducing noise N0. Specifically, first filter 15 generates the cancellation signal by applying (multiplying) an adaptive filter to the first signal that has been input to first input terminal 11 (S11). First input terminal 11 is an example of a first input unit. First input terminal 11 is made of a metal, for example. First filter 15 is implemented by so-called a FIR filter or an IIR filter. First filter 15 outputs the generated cancellation signal to cancellation signal output terminal 12.

Cancellation signal output terminal 12 is an example of a cancellation signal output unit and is made of a metal, for example. Cancellation sound source 52 is connected to cancellation signal output terminal 12. This allows the cancellation signal to be output to cancellation sound source 52 via cancellation signal output terminal 12. Cancellation sound source 52 outputs cancellation sound N1 based on the cancellation signal.

On the other hand, second filter 16 generates a filtered reference signal (S12). The filtered reference signal is obtained by compensating (or correcting) the first signal by a simulated transfer characteristics that simulates an acoustic transfer characteristic from cancellation signal output terminal 12 to error signal input terminal 13. The simulated transfer characteristics are, for example, actually measured in space 57 beforehand and stored in memory storage 18. Note that the simulated transfer characteristic may be determined by an algorithm that does not use values determined in advance.

Memory storage 18 stores the simulated transfer characteristics. Memory storage 18 also stores later-described adaptive filter coefficients and the like. Memory storage 18 may specifically be implemented by, for example, a semiconductor memory. Note that when first signal processor 14 is implemented by a computer processor such as a DSP, memory storage 18 also stores a control program to be executed by the computer processor. Memory storage 18 may also store other parameters to be used in the signal processing performed by first signal processor 14.

Based on the error signal and the generated filtered reference signal, updater 17 successively updates adaptive filter coefficient W (S13).

Error signal input terminal 13 is an example of an error signal input unit, and is made of a metal, for example. Error signal input terminal 13 receives an error signal corresponding to a residual sound obtained by the interference between noise NO and cancellation sound N1 that is generated from cancellation sound source 52 corresponding to the cancellation signal. As described previously, error signal source 53 outputs the error signal.

Specifically, updater 17 calculates adaptive filter coefficient W so that the sum of squares of the error signal becomes minimum by using a Least Mean Square (LMS) technique, and outputs the calculated adaptive filter coefficient to first filter 15. That is, updater 17 successively updates adaptive filter coefficient W. Adaptive filter coefficient W is represented by the following equation (1), where the vector of the error signal is “e” and the vector of the filtered reference signal is “R”. Note that “n” is a natural number, which represents the “n”-th sample in sampling period “Ts”. Also, “μ” is a scalar quantity which is a step size parameter that determines the quantity of adaptive filter coefficient W to be updated per one sampling.

W(n+1)=W(n)−μ*e(n)·R(n) (Eq. 1)

Updater 17 may update adaptive filter coefficient W by using a method other than the LMS technique.

### [Abnormality Determination Operation]

Next, the abnormality determination operation of noise canceller 10 will be described with reference to FIG. 5, in addition to FIG. 3. FIG. 5 is a flowchart illustrating the abnormality determination operation of noise canceller 10.

First, abnormality determiner 20 acquires the first signal via first input terminal 11 (S21). Next, abnormality determiner 20 determines whether or not an abnormality is present in fuel tank 56 by using the acquired first signal (S22). Note that the first signal used by abnormality determiner 20 for the determination is identical to the first signal used by first signal processor 14 for generating the cancellation signal. Both abnormality determiner 20 and first signal processor 14 use the first signal that has been input to first input terminal 11 as it is.

If abnormality determiner 20 determines that an abnormality is present in fuel tank 56 (Yes in S22), notifier 21 outputs a notification signal for reporting the abnormality of fuel tank 56 (S23). The notification signal is output to vehicle controller 55 via notification signal output terminal 22. Notification signal output terminal 22 is an example of a notification signal output unit, and is made of a metal, for example.

Based on such a notification signal, vehicle controller 55 controls a display unit (not shown), provided within vehicle body 54, so that an image indicating the abnormality in fuel tank 56 is displayed. Alternatively, vehicle controller 55 controls a speaker provided within vehicle body 54 such that the speaker outputs a sound indicating the abnormality in fuel tank 56. Cancellation sound source 52 may also serve as this speaker. Alternatively, another speaker (not shown) provided separately may serve as this speaker.

This enables noise canceller 10 to notify a vehicle-occupant of vehicle 50 of the abnormality in fuel tank 56. It should be noted that notifier 21 may output a video signal or an audio signal as the notification signal directly to the display unit or the speaker. In other words, the notification that indicates the abnormality in fuel tank 56 may be carried out without being controlled by vehicle controller 55.

In this way, notifier 21 may be provided. If abnormality determiner 20 determines that an abnormality is present in a specific part, notifier 21 outputs a notification signal for notifying the abnormality of the specific part.

This enables noise canceller 10 to report the abnormality of the specific part.

If abnormality determiner 20 determines that no abnormality is present in fuel tank 56 (No in S22), the abnormality determination operation ends.

Each of abnormality determiner 20 and notifier 21 is specifically implemented by a microcomputer. However, it is also possible that each of abnormality determiner 20 and notifier 21 may be implemented by a computer processor or a dedicated circuit. The hardware of each of abnormality determiner 20 and notifier 21 may be implemented by a combination of any two or more of a computer processor, a microcomputer, and a dedicated circuit. When abnormality determiner 20 and notifier 21 are operated by executing control programs, such control programs are stored in memory storage 18. In addition, the determination conditions (such as later-described threshold values) that are used by abnormality determiner 20 may also be stored in memory storage 18.

### [Details of Abnormality Determination Method]

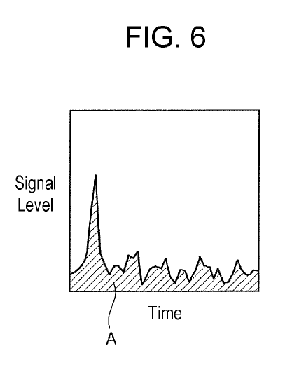

Next, a method of determining whether or not an abnormality is present in step S22 will be described. FIG. 6 is a schematic view illustrating the signal waveform of the first signal.

Abnormality determiner 20 determines that an abnormality is present in fuel tank 56 when, for example, a large vibration is applied to fuel tank 56. Here, as illustrated in FIG. 6, the greater the vibration detected by sensor 51, the higher the signal level of the first signal that is detected by sensor 251 will be. In other words, the greater the vibration is, the higher the signal level is.

Accordingly, abnormality determiner 20 detects, for example, the peak of the signal level of the first signal, and determines whether or not an abnormality is present in fuel tank 56 based on the detected peak. Specifically, abnormality determiner 20 detects the peak of the absolute value of the signal level of the first signal. Then, if the peak of the detected absolute value is equal to or greater than a threshold value, abnormality determiner 20 determines that an abnormality is present in fuel tank 56. On the other hand, if the peak of the absolute value of the signal level of the first signal is less than the threshold value, abnormality determiner 20 determines that no abnormality is present in fuel tank 56. It is also possible that abnormality determiner 20 detects the peak of the square of the first signal and may determine whether or not an abnormality is present in fuel tank 56 based on the detected peak of the square of the first signal.

This enables abnormality determiner 20 to determine whether or not an abnormality is present in fuel tank 56 based on the magnitude of instantaneous vibration.

It is also possible that abnormality determiner 20 calculates integral value A (the area of the hatched region in FIG. 6) of the first signal during a predetermined period and determines whether or not an abnormality is present in fuel tank 56 based on calculated integral value A. Specifically, if integral value A of the first signal is equal to or greater than a predetermined value, abnormality determiner 20 determines that an abnormality is present in fuel tank 56, whereas if integral value A of the first signal is less than the predetermined value, abnormality determiner 20 determines that no abnormality is present in fuel tank 56.

This enables abnormality determiner 20 to determine whether or not an abnormality is present in fuel tank 56 based on the vibration quantity (i.e., whether or not the vibration is applied continuously).

Abnormality determiner 20 may also determine whether or not an abnormality is present based on, for example, a comparison of the absolute value of the first signal, or the squared value of the first signal, with a respective threshold value. Specifically, if the absolute value of the first signal or the squared value of the first signal is equal to or greater than the respective threshold value, abnormality determiner 20 may determine that an abnormality is present in fuel tank 56, whereas if both the absolute value of the first signal and the squared value of the first signal are less than the respective threshold values, abnormality determiner 20 may determine that no abnormality is present in fuel tank 56.

### Second Exemplary Embodiment

The vehicle (vehicle body) may be provided with two or more vibration detectors. In this case, the active noise reduction device may acquire respective signals from the two or more vibration detectors to perform the noise reduction operation and the abnormality determination operation. Such vehicle 150 and active noise reduction device (hereafter “noise canceller”) 110 according to a second exemplary embodiment will be described in the following.

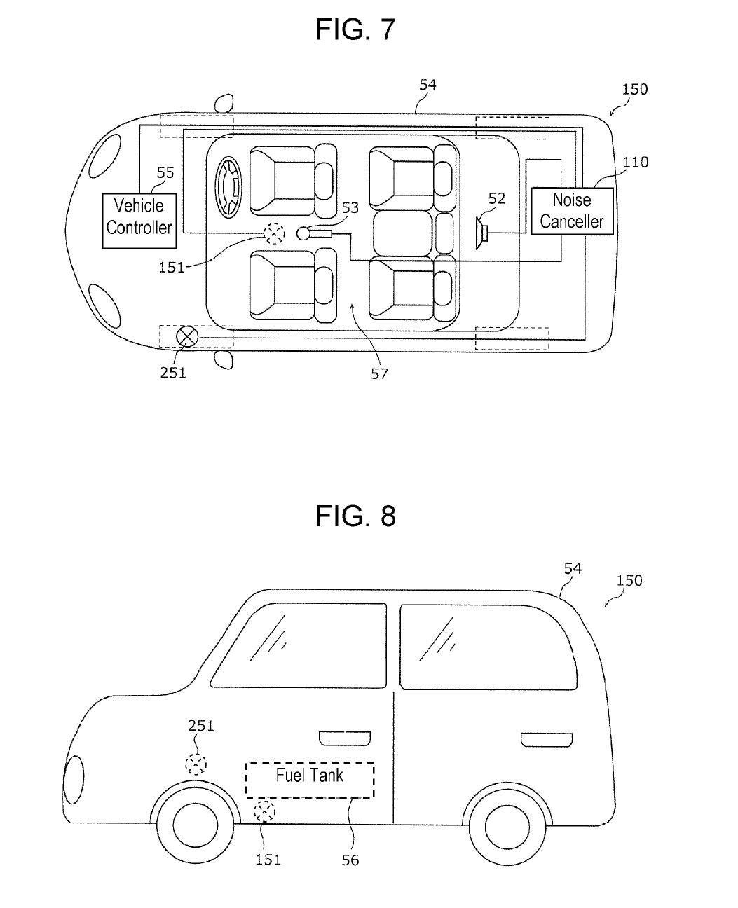

FIG. 7 is a schematic view illustrating vehicle 150 incorporating noise canceller 110, viewed from top. FIG. 8 is a schematic view illustrating vehicle 150, viewed from a side. In the present exemplary embodiment, the description will be made primarily on parts that are different from the first exemplary embodiment, and the description of the same or similar parts will not be repeated.

Vehicle 150 includes noise canceller 110, first and second vibration detectors 151 and 251 (hereafter “sensors 151 and 251”), cancellation sound source 52, error signal source 53, vehicle body 54, vehicle controller 55, and fuel tank 56. That is, a primary difference of vehicle 150 from vehicle 50 is that vehicle 150 has sensor 251 in addition to sensor 151. Sensor 251 is specifically an acceleration sensor. However, sensor 251 may be another type of sensor that can detect a vibration.

Like sensor 51, sensor 151 is fitted to fuel tank 56. In contrast, sensor 251 is fitted to a subframe near the left front wheel (or to a wheel fender of the left front wheel). Thus, sensor 151 and sensor 251 are fitted to different parts of vehicle body 54. Sensor 251 outputs a second signal that indicates the magnitude of vibration in a part (i.e., the subframe) of vehicle 50 that is other than fuel tank 56.

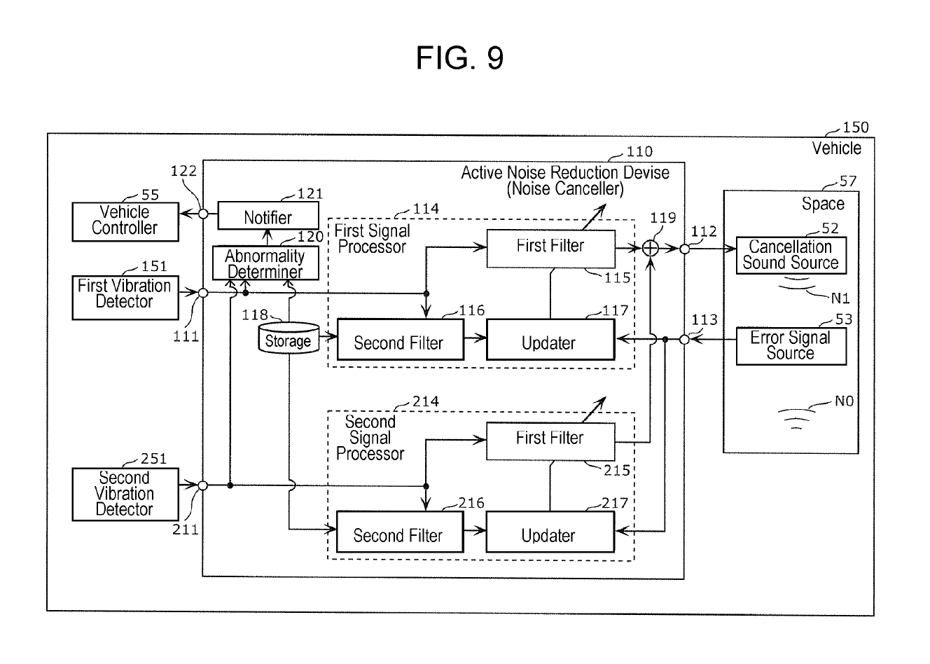

Next, the functional configuration of noise canceller 110 will be described. FIG. 9 is a block diagram illustrating the functional configuration of noise canceller 110.

Noise canceller 110 includes first input terminal 111, second input terminal 211, cancellation signal output terminal 112, error signal input terminal 113, first signal processor 114, memory storage 118, adder 119, abnormality determiner 120, notifier 121, and notification signal output terminal 122. First signal processor 114 includes first filter 115, second filter 116, and updater 117. Second signal processor 214 includes second filter 215, second filter 216, and updater 217.

First signal processor 114 generates a cancellation signal that is used to output a cancellation sound for reducing noise NO by using the first signal input to first input terminal 111. Second signal processor 214 generates a cancellation signal that is used to output the cancellation sound for reducing noise NO by using the second signal input to second input terminal 211. The functions and operations of first signal processor 114 and second signal processor 214 are the same as those of first signal processor 14.

Second input terminal 211 is an example of a second input unit. Second input terminal 211 receives the second signal, which is output by sensor 251. Second input terminal 211 is made of a metal, for example.

Adder 119 adds the cancellation signal output from first signal processor 114 and the cancellation signal output from second signal processor 214, to generate an added cancellation signal. Then, adder 119 outputs the added cancellation signal to the cancellation signal output terminal 112.

Adder 119 is implemented by, for example, a computer processor, such as a DSP. However, adder 119 may also be implemented by an adder circuit that uses a microcomputer, an operational amplifier, or the like.

Abnormality determiner 120 determines whether or not an abnormality is present in fuel tank 56 by using the first signal and the second signal both input thereto. That is, a difference of abnormality determiner 120 from abnormality determiner 20 is that abnormality determiner 120 uses the second signal in addition to the first signal in determining whether or not an abnormality is present in fuel tank 56.

Specifically, sensor 251 outputs the second signal, which indicates a vibration in a part other than the specific part. Abnormality determiner 120 determines whether or not an abnormality is present in the specific part by using the first signal and the second signal.

This enables noise canceller 110 to determine whether or not an abnormality is present in the specific part based on a comparison between a vibration in the specific part and a vibration in the part other than the specific part.

[Abnormality Determination Method according to the Second Exemplary Embodiment]

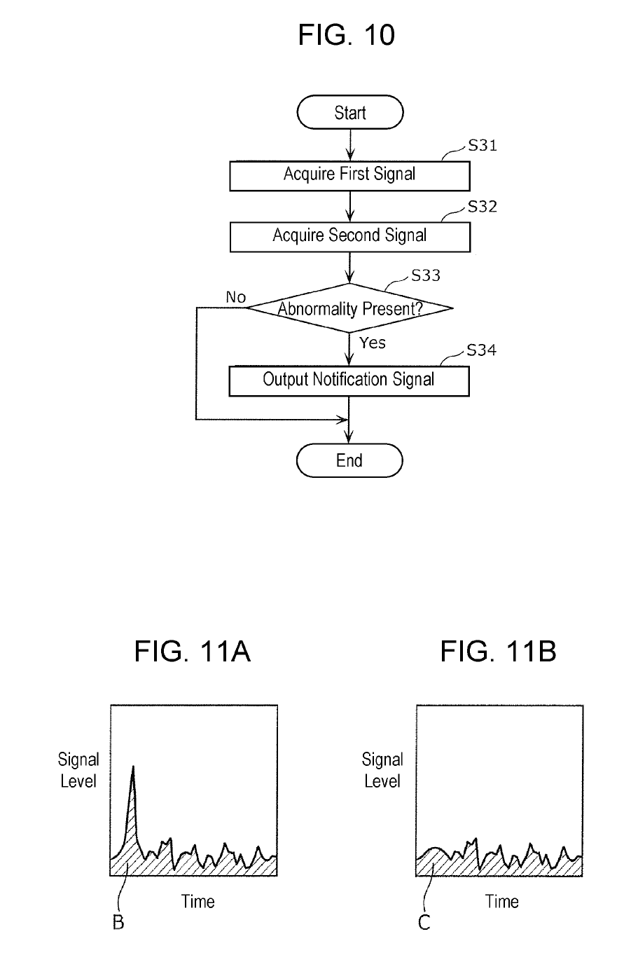

Next, the abnormality determination operation of noise canceller 110 will be described with reference to FIG. 10, in addition to FIG. 9. FIG. 10 is a flowchart illustrating the abnormality determination operation of noise canceller 110.

First, abnormality determiner 120 acquires the first signal from sensor 151 via first input terminal 111 (S31). Abnormality determiner 120 also acquires the second signal from sensor 251 via second input terminal 211 (S32). Next, abnormality determiner 120 determines whether or not an abnormality is present in fuel tank 56 by using the first signal and the second signal both input thereto (S33).

If abnormality determiner 120 determines that an abnormality is present in fuel tank 56 (Yes in S33), notifier 121 outputs a notification signal for reporting the abnormality of fuel tank 56 (S34). The notification signal is output to vehicle controller 55 via notification signal output terminal 122.

If abnormality determiner 120 determines that no abnormality is present in fuel tank 56 (No in S33), the abnormality determination operation ends.

[Details of Abnormality Determination Method according to the Second Exemplary Embodiment]

Next, a method of determining whether or not an abnormality is present in step S33 will be described below. FIGS. 11A and 11B are schematic views respectively illustrating the signal waveform of the first signal and the signal waveform of the second signal.

Abnormality determiner 120 determines whether or not an abnormality is present in fuel tank 56 based on, for example, a difference between the input first signal (FIG. 11A) and the input second signal (FIG. 11B) both input thereto. Specifically, abnormality determiner 120 calculates the difference between the absolute value of the first signal and the absolute value of the second signal, and if the calculated difference is equal to or greater than a threshold value, abnormality determiner 120 determines that an abnormality is present in fuel tank 56. If the calculated difference is less than the threshold value, abnormality determiner 120 determines that no abnormality is present in fuel tank 56.

That is, abnormality determiner 120 may determine whether or not an abnormality is present in the specific part based on the difference between the first signal and the second signal.

This enables noise canceller 110 to determine that an abnormality is present in the specific part when a greater vibration is applied to the specific part than that applied to a part other than the specific part. It is also possible that abnormality determiner 120 calculates the difference between the square of the first signal and the square of the second signal.

When similar vibrations are applied to the subframe on which sensor 251 is fitted and fuel tank 56 on which sensor 151 is fitted, it is considered that vibrations are applied to the entire vehicle 150. In such a case, the calculated difference is smaller. On the other hand, when the vibration applied to fuel tank 56 is greater than that applied to the subframe, the difference is larger. Thus, by using the above-described difference, abnormality determiner 120 is able to determine that an abnormality is present in fuel tank 56 when the vibration applied to fuel tank 56 is greater than that applied to the subframe. Thus, the reliability of the abnormality determination is increased.

It is also possible that abnormality determiner 120 calculates integral value B (the area of the hatched region in FIG. 11A) of the first signal and integral value C (the area of the hatched region in FIG. 11B) of the second signal, both during a predetermined period. Abnormality determiner 120 may determine whether or not an abnormality is present in fuel tank 56 based on the difference between calculated integral values B and C. Specifically, if the difference between integral value B and integral value C is equal to or greater than a predetermined value, abnormality determiner 120 determines that an abnormality is present in fuel tank 56, whereas if the difference between integral value B and integral value C is less than the predetermined value, abnormality determiner 120 determines that no abnormality is present in fuel tank 56.

This enables abnormality determiner 120 to determine that an abnormality is present in fuel tank 56 when the vibration quantity applied to fuel tank 56 is greater than the vibration quantity applied to the subframe

Thus, abnormality determiner 120 may determine whether or not an abnormality is present in the specific part based on the difference between an integral value of the first signal and an integral value of the second signal.

This enables noise canceller 110 to determine that an abnormality is present in the specific part when the vibration quantity for the specific part is greater than that for a part other than the specific part.

### Other Exemplary Embodiments

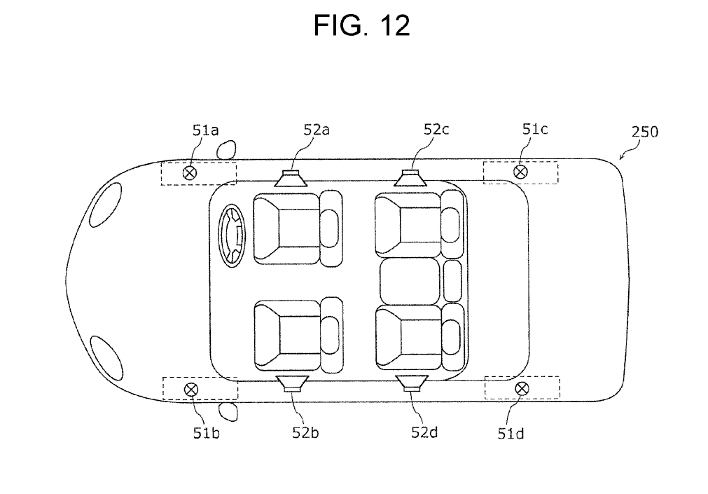

The first and second exemplary embodiments have been described hereinabove; however, the present disclosure is not limited to the first and second exemplary embodiments. For example, the arrangements of the vibration detector and the cancellation sound source that are described in the first and second exemplary embodiments are merely exemplary. FIG. 12 is a view illustrating an example of an arrangement of vibration detectors and cancellation sound sources.

As in vehicle 250 shown in FIG. 12, it is possible to employ four vibration detectors 51a to 51d and four cancellation sound sources 52a to 52d in a vehicle to which the active noise reduction device is applied. Vibration detector 51a is fitted to a subframe near the right front wheel, vibration detector 51b is fitted to a subframe near the left front wheel, vibration detector 51c is fitted to a subframe near the right rear wheel, and vibration detector 51d is fitted to a subframe near the left rear wheel. Cancellation sound source 52a is fitted to the right front door, cancellation sound source 52b is fitted to the left front door, cancellation sound source 52c is fitted to the right rear door, and cancellation sound source 52d is fitted to the left rear door.

In such vehicle 250, for example, one of vibration detectors 51a to 51d is fitted to a specific part, such as a fuel tank, instead of the subframe, so that the one of vibration detectors 51a to 51d is used as the first vibration detector. Alternatively, in vehicle 250, an additional vibration detector may be provided in addition to vibration detectors 51a to 51d and fitted to a specific part, such as a fuel tank, so that the additional vibration detector can be used as the first vibration detector. The second vibration detector may also be configured in a like manner.

In the first and second exemplary embodiments, the first vibration detector is fitted to the fuel tank. However, the first vibration detector may be fitted to a specific part other than the fuel tank. The first vibration detector may be fitted to any part within the vehicle that serves the subject of abnormality detection. It is enough that the second vibration detector is fitted to a part other than the part to which the first vibration detector is fitted, and the part to which the second vibration detector is fitted is not limited either. The second vibration detector may be fitted to, for example, a component such as a wheel, a wheel fender, a knuckle, an arm, a subframe, or a vehicle body.

The configurations of the active noise reduction devices according to the first and second exemplary embodiments are merely exemplary. For example, the active noise reduction device may include other elements, such as a D/A converter, a filter, a power amplifier, and an A/D converter.

Furthermore, the processes that are performed by the active noise reduction devices according to the first and second exemplary embodiments are merely exemplary. For example, part of the digital signal processing described in the foregoing exemplary embodiments may be implemented by analog signal processing.

Moreover, in the first and second exemplary embodiments, a process executed by a specific processor may be executed by another processor. In addition, it is possible to change the order of a plurality of processes to be executed. It is also possible to execute a plurality of processes in parallel.

Each of the constituent elements in the first and second exemplary embodiments may be composed of dedicated hardware, or may be implemented by executing a software program that is suitable for each of the constituent elements. Each of the constituent elements may also be implemented by reading out a software program recorded in a storage medium, such as a hard disk or a semiconductor memory, and executing the software program by a program execution unit, such as a CPU or a computer processor.

Furthermore, the constituent elements may be circuits (or integrated circuits). Such circuits may form a circuitry as a whole or may be separate circuits from each other. Also, each of these circuits may be a general-purpose circuit or a dedicated circuit.

The general or specific aspect of the present disclosure may be implemented by systems, devices, methods, integrated circuits, computer programs, or computer-readable non-transitory storage media such as CD-ROMs. The general or specific aspect of the present disclosure may also be implemented by any combination of systems, devices, methods, integrated circuits, computer programs, and computer-readable non-transitory storage media.

For example, the present disclosure may be implemented as an abnormality determination method to be executed by an active noise reduction device (a computer or a DSP), or as a program for causing a computer or a DSP to execute the abnormality determination method. Furthermore, the present disclosure may be implemented as a vehicle or a noise reduction system that includes an active noise reduction device according to the foregoing exemplary embodiments, a first vibration detector, a cancellation sound source, and an error signal source.

The order in which the plurality of processes are executed in the operations of the active noise reduction device described in the first and second exemplary embodiments is merely exemplary. It is possible to change the order of the plurality of processes to be executed. It is also possible to execute the plurality of processes in parallel.

In addition, the present disclosure also includes various embodiments obtained by various modifications made to the exemplary embodiments that are conceivable by those skilled in the art, and various embodiments implemented by any combinations of the constituent elements and features of the exemplary embodiments without departing from the scope of the present disclosure.

The active noise reduction device according to the present disclosure is useful, for example, as a device that reduces the noise in a compartment of a vehicle and also determines whether or not an abnormality is present in a specific part of the vehicle.

What is claimed is:

1. An active noise reduction device for reducing noise in a space within a vehicle body, the active noise reduction device comprising:
a first input unit configured to acquire a first signal from a first vibration detector fitted to the vehicle body, the first signal indicating a vibration in a specific part of the vehicle body;
a signal processor configured to generate a cancellation signal that is used to output a cancellation sound for reducing the noise, by using the first signal as a reference signal having a correlation with the noise; and
an abnormality determiner configured to determine whether or not an abnormality is present in the specific part by using the first signal.

2. The active noise reduction device according to claim 1, wherein the abnormality determiner determines whether or not the abnormality is present in the specific part based on a peak value of the first signal.

3. The active noise reduction device according to claim 1, wherein the abnormality determiner determines whether or not the abnormality is present in the specific part based on an integral value of the first signal.

4. The active noise reduction device according to claim 1, wherein the abnormality determiner determines whether or not the abnormality is present in the specific part based on a comparison of an absolute value of the first signal, or a squared value of the first signal, with a threshold value.

5. The active noise reduction device according to claim 1, further comprising:
a second input unit acquiring a second signal from a second vibration detector fitted to the vehicle body, the second signal indicating a vibration in a part other than the specific part,
wherein the abnormality determiner uses the first signal and the second signal to determine whether or not the abnormality is present in the specific part.

6. The active noise reduction device according to claim 5, wherein the abnormality determiner determines whether or not the abnormality is present in the specific part based on a difference between the first signal and the second signal.

7. The active noise reduction device according to claim 5, wherein the abnormality determiner determines whether or not the abnormality is present in the specific part based on a difference between an integral value of the first signal and an integral value of the second signal.

8. The active noise reduction device according to claim 1, wherein the specific part is a fuel tank provided in the vehicle body.

9. The active noise reduction device according to claim 1, further comprising a notifier configured to output a notification signal for reporting the abnormality of the specific part when the abnormality determiner determines that the abnormality is present in the specific part.

10. The active noise reduction device according to claim 1, further comprising:
a first filter configured to generate the cancellation signal by applying an adaptive filter to the first signal;
a cancellation signal output unit configured to output the cancellation signal;
an error signal input unit configured to acquire an error signal that corresponds to a residual sound obtained by an interference between the cancellation sound that is output and the noise;
a second filter configured to generate a filtered reference signal by correcting the first signal with a simulated transfer characteristic that simulates an acoustic transfer characteristic from the cancellation signal output unit to the error signal input unit; and
an updater configured to successively update a coefficient of the adaptive filter, by using the error signal and the filtered reference signal.

11. A vehicle comprising:
a vehicle body provided with a space therein;
a first vibration detector fitted to the vehicle body and configured to output a first signal indicating a vibration in a specific part of the vehicle body; and
the active noise reduction device according to claim 1.

12. An abnormality determination method performed by an active noise reduction device for reducing noise in a space within a vehicle body, the method comprising:
acquiring a first signal that is output by a first vibration detector fitted to a specific part of the vehicle body, the first signal indicating a magnitude of vibration;
generating a cancellation signal that is used to output a cancellation sound for reducing the noise, by using the first signal as a reference signal having a correlation with the noise; and
determining whether or not an abnormality is present in the specific part by using the first signal.
